(19) United States
(12) Patent Application Publication
(10) Pub. No.: US 2017/0076340 A1
(43) Pub. Date: Mar. 16, 2017

(54) INFORMATIVE PREDICTION FOR PRINTED CIRCUIT BOARD COST

(71) Applicant: International Business Machines Corporation, Armonk, NY (US)

(72) Inventors: Jonathan R.M. Hosking, Scarsdale, NY (US); Anuradha Rao, Hopewell Junction, NY (US); Hongxia Yang, Pleasantville, NY (US)

(21) Appl. No.: 14/853,369

(22) Filed: Sep. 14, 2015

(51) Int. Cl. G06Q 30/02; G06Q 10/06

(52) U.S. Cl. CPC G06Q 30/0283; G06Q 10/06313

(57) ABSTRACT

A method of estimating cost of a printed circuit board comprises receiving a set of parameters for a printed circuit board (PCB) design; statistically classifying the PCB design into one of a plurality of categories; generating a regression model corresponding to the respective category of the PCB design based on statistical analysis of historical data; and determining a probability distribution for one or more coefficients in the regression model based on informative data. The informative data includes data regarding expected relationships between one or more predictors in the regression model and cost of the printed circuit board. The method further comprises determining a respective value for each of the one or more coefficients based on the probability distribution; and generating a cost estimate for the PCB design based on the regression model using the respective determined values for each of the one or more coefficients.

### BACKGROUND

In the modern electronics and computer industry, there is a demand for printed circuit boards (PCBs) of varying complexity and cost. Organizations often require as many as 400 different electronic PCBs to support even a single server group. The number of components on each card varies between 20 and 900, and the cost per card varies. Estimating the costs of raw cards is a challenging task. Underestimating the production costs for a printed circuit board can result in losses for a company, whereas overestimating the cost can take away the company competitive advantage.

### SUMMARY

In one embodiment, a method of estimating cost of a printed circuit board is provided. The method comprises receiving a set of parameters for a printed circuit board (PCB) design; statistically classifying the PCB design into one of a plurality of categories; generating a regression model corresponding to the respective category of the PCB design based on statistical analysis of historical data; and determining a probability distribution for one or more coefficients in the regression model based on informative data. The informative data includes data regarding expected relationships between one or more predictors in the regression model and cost of the printed circuit board. The method further comprises determining a respective value for each of the one or more coefficients based on the probability distribution; and generating a cost estimate for the PCB design based on the regression model using the respective determined values for each of the one or more coefficients.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a flow chart depicting one embodiment of an example method of predicting costs of a printed circuit board.

FIG. 2 is a block diagram of one embodiment of an example printed circuit board cost modeling system.

FIG. 3 is an illustrative grid depicting four example categories used for classification of a printed circuit board.

FIGS. 4-7 are graphs depicting comparison of results from an informative Bayesian printed circuit board cost estimation and a conventional technique for estimating printed circuit board cost.

FIG. 8 depicts one embodiment of an example cloud computing environment.

FIG. 9 depicts one embodiment of example abstraction model layers.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

The embodiments described herein use physical understanding of the raw card production process to identify key predictors and the form of the prediction model. For example, some embodiments take into account the supplier geography and the overhead associated with the geography to pick a manufacturer for a given complexity of a printed circuit board design and uses historical data to predict a cost estimate of the printed circuit board design.

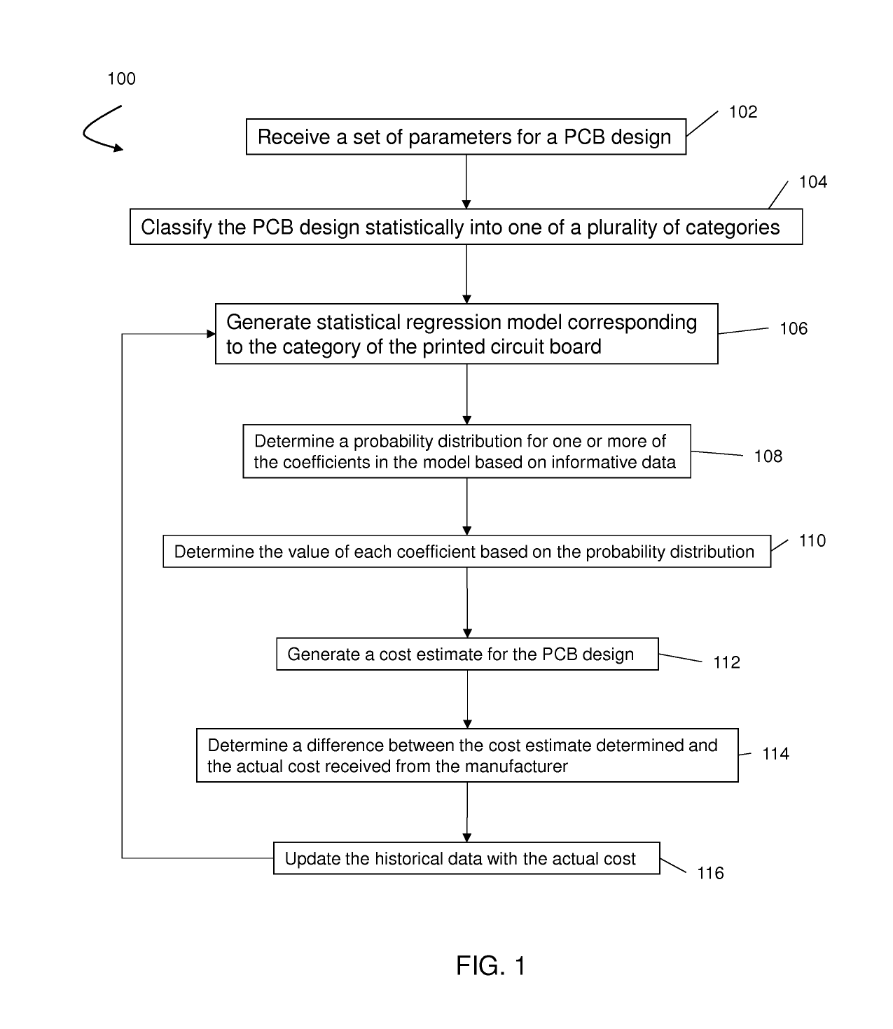

FIG. 1 is a flow chart depicting one embodiment of a method 100 of predicting costs of a printed circuit board (PCB). At block 102, a set of parameters for a printed circuit board design are received. The design parameters can be received in any suitable format for representing the printed circuit board design. For example, in some embodiments, the parameters can be in a standard format such as, but not limited to, a gerber design file. In other embodiments, the parameters can be in a proprietary format used to communicate printed circuit board design parameters. The parameters can include manufacturing details such as, but not limited to, the number of layers in the PCB, the number of holes needed, the laminate material used to create the PCB, the type of core, the number of buried vias, types of tests needed to ensure that the PCB functions properly, dimensions of the PCB (e.g. surface area, thickness, width, etc.), material types used (e.g. gold, copper, etc.), manufacturing techniques used (e.g. back drilling), etc.

At block 104, the PCB design is classified into one of a plurality of statistical categories based on one or more of the parameters. For example, the plurality of statistical categories can be determined based on a statistical analysis of historical data. The historical data can include data regarding parameters (also referred to herein as attributes) of previous PCB designs and associated costs. The historical data can be analyzed to determine which data sets are well clustered with a suitably low statistical variance within the data set but a high degree of variance between data sets. For example, thresholds or ranges can be set to identify data sets which have low statistical variance as well as to define a high degree of variance between the data sets. In addition, the inclusion of more or less attributes in the classification may facilitate this statistical analysis. Each data set exhibiting the desired characteristics corresponds to a respective category.

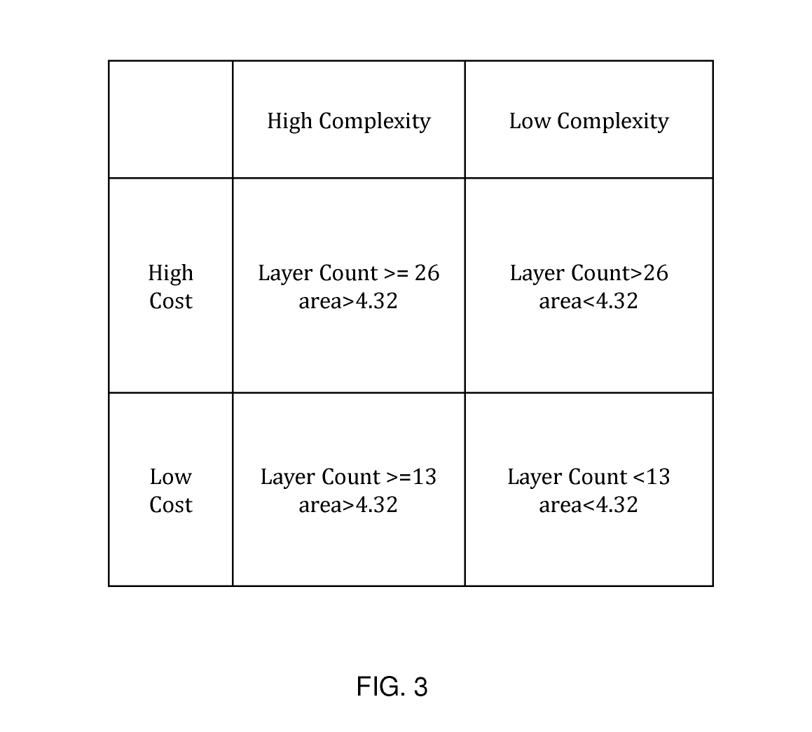

For example, FIG. 3 is an illustrative grid depicting four example categories used for classification of a printed circuit board. Although four categories are depicted in this example, it is to be understood that, in other embodiments, any number of categories and attributes can be used. In addition, it is to be understood that the specific example attributes and example values are provided for purposes of explanation and that other attributes and values can be used in other embodiments. In the example shown in FIG. 3, the four categories are high cost/high complexity, high cost/low complexity, low cost/high complexity, and low cost/low complexity. In particular, the grid shown in FIG. 3 depicts the attributes and respective values for each of the four example categories. In such an embodiment, the printed circuit board is classified into one of the four categories based on the number of layers and the area of the printed circuit board. In some embodiments, the values for each attribute can be adjusted over time and/or can be user selectable.

Returning to FIG. 1, once the printed circuit board is classified into a category at block 104, a statistical regression model corresponding to the category of the printed circuit board is built or generated at block 106 based on statistical analysis of historical data. The historical data can include, but is not limited to, previous cost estimates for other printed circuit boards in the same category, materials and specifications of other printed circuit boards in the same category, standard and non-standard panel sizes, effective areas and panel utilizations, materials future costs, cost variations from different suppliers or manufacturers, manufacturers' quotes, and information about respective manufacturers. The information about respective manufacturers can include, but is not limited to, manufacturing capabilities and capacity, acceptable profit margins, manufacturers' specializations, qualifications of the person, department, or company creating the PCB design, geographic differences between different manufacturers (e.g. labor rate, shipping costs, taxes), etc. Thus, the historical data is objective data regarding manufacturers and other previous printed circuit board designs.

A predictor is an attribute or parameter of the printed circuit board used in the regression model to estimate cost. For example, equation 1 is one illustrative example of a model of the cost estimate having a plurality of predictors.

CostEstimate=a1*number_of_layers+a2*card_thickness+a3*number_of_holes+a4*area+a5*layer_material. Eq. 1

In equation 1, the predictors are number_of_layers, card_thickness, number_of_holes, area, and layer_material. The coefficients are a1, a2, a3, a4, and a5. At block 108, informative data is used to determine a probability distribution for one or more of the coefficients in the model generated at block 104. As used herein, informative data is data regarding expected relationships between one or more predictors and cost of the printed circuit board. Thus, the informative data enables embodiments to account for expected relationships between the predictors and the estimated cost. For example, it may be expected that increasing the area will increase the cost differently for a high cost/high complexity PCB design (e.g. 10-30 percent cost increase) than for a low cost/low complexity PCB design (e.g. 5 percent cost increase). Similarly, the inclusion of gold layers, particular fabrication techniques, etc. may be expected to affect the cost and the effect may be expected to be different for different categories. The informative data enables these expectations to be incorporated into the model. In particular, in this embodiment, a Bayesian approach is used to incorporate the informative data.

As understood by one of skill in the art, a Bayesian approach includes a prior probability distribution for coefficients of the predictors in the model. In method 100, the informative data is used to determine the prior probability distribution for use in the application of Bayes' formula to the cost estimation model. As understood by one of skill in the art, Bayes' formula has the form p(θ|D)=p(D|θ) p(θ)/∫p(D|θ*) p(θ*) dθ*, where θ denotes the vector of model parameters (in Eq. 1, the parameters are a1 through a5), D denotes historical training data, p(θ) denotes a prior distribution of the parameters, p(D|θ) denotes a distribution of the data given specified values of the parameters (the likelihood function of the statistical model), and p(θ|D) denotes the posterior distribution of the parameters given the data. The formula specifies, for example, how prior beliefs about the magnitudes of the model parameters, expressed in the distribution p(θ), should be updated in the view of the data.

The informative data can be input by a user or retrieved from a database of information. The informative data can include expectations based on prior performance. For example, based on the cost of a given material, an expected increase or decrease can be estimated and input based on a change in the material. Additionally, the informative data can enable the incorporation of experts' judgment. For example, if the historical data indicates a sudden change in cost associated with a particular manufacturer, an expert having knowledge of the cause of the change can provide the informative data to be incorporated. For example, the knowledge that there were initial higher costs due to a learning curve which have now dropped as the manufacturer has more experience can be included.

At block 110, the value of each coefficient is determined based on the probability distribution. In particular, in this embodiment, an expectation maximization algorithm is used to determine the value of each coefficient. For example, the expectation maximization algorithm alternates between determining the likelihood or probability of the logarithmic transformation of the regression model based on current values of the coefficients and computing respective updated values for the coefficients which increase the likelihood of the logarithmic transformation. The updated values for the coefficients become the current values for the next iteration of the expectation maximization algorithm. The expectation maximization algorithm repeats until values of the coefficients are determined which maximize the likelihood of the logarithmic transformation. Thus, the probability distribution based on the informative data is used to help ensure that the magnitude and sign of the coefficients are consistent with physical understanding of the printed circuit board design and manufacturing processes. In other words, this helps ensure that changes in printed circuit board design specification lead to changes in cost that are in the direction implied by the physical nature of the production process.

At block 112, a cost estimate for the PCB design is generated based on the statistical regression model using the coefficients determined at block 110. At block 114, a difference between the cost estimate determined at block 110 and the actual cost received from the manufacturer is determined. For example, the difference can be estimated when an actual price quotation is received. At block 116, the historical data is updated with the actual cost received from the manufacturer and the method 100 returns to block 106 where the regression model is updated based on the difference calculated at block 114. Since the method 100 described above includes the use of a Bayesian approach using informative data, the method 100 is also referred to herein as an informative Bayesian method.

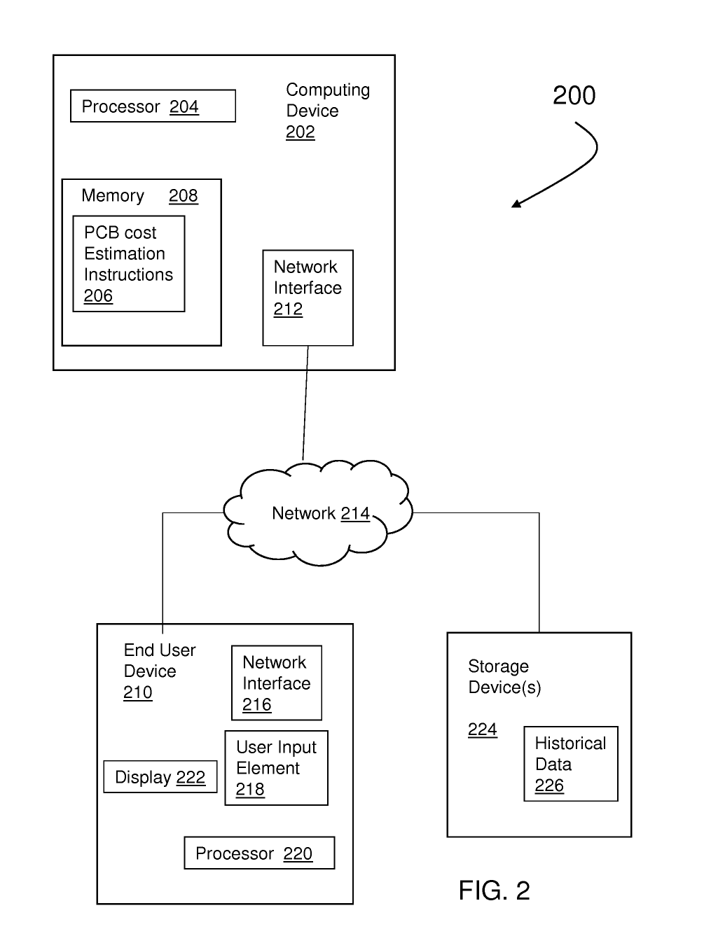

FIG. 2 is a block diagram of one embodiment of an illustrative printed circuit board cost modeling system 200. The system 200 is configured to implement the method of FIG. 1 discussed above. In particular, the computing device 202 includes a processor 204 configured to execute printed circuit board cost estimation instructions 206 stored on memory 208 to implement embodiments of the method 100 described above. The computing device 202 can operate in any type of environment that is capable of executing software instructions. For example, the computing device 202 can be implemented as a high-speed computer processing device, such as a mainframe computer, to manage a large volume of operations managed by an entity such as an enterprise or commercial business that implements PCB cost modeling.

In addition, the embodiment of system 200 in FIG. 2 includes one or more end user devices 210 through which users at one or more geographic locations may contact the computing device 202. The end user device 210 is communicatively coupled to the computing device 202 via one or more networks 214. To that end, the computing device 202 includes a network interface 212 in this example. Hence, in some embodiments, the PCB modeling system can be implemented using a cloud computing environment. An example cloud computing environment is described in more detail below.

In this embodiment, the end user device 210 is implemented using a processing device configured to execute instructions for communicating with and providing data to the computing device 210. The end user device 210 can be implemented as a personal computer (e.g., a laptop or desktop computer), a personal digital assistant, a mobile device, or a host attached terminal. The end user device 210 includes a network interface 216 configured to communicate with the computing device 202 via the network 214, a user input element 218 configured to receive input from a user, a display 222 configured to display data for a user, and a processor 220 configured to process data and commands. Thus, in some embodiments, the end user device 210 is configured to provide a PCB design to the computing device 202 via the network and to receive the cost estimate from the computing device 202. In some such embodiments, the processes described above with respect to FIG. 1 are performed by the computing device 202 executing the PCB cost estimation instructions 206. In other embodiments, the processes described above with respect to FIG. 1 are distributed or shared by the end user device 210 and the computing device 202 (e.g., by providing an applet to the end user device 210). In addition, in some embodiments, the user input element is an interface for receiving informative data input by a user, as discussed above.

The network 214 can be implemented as any type of known network including, but not limited to, a wide area network (WAN), a local area network (LAN), a global network (e.g., Internet), a virtual private network (VPN), and an intranet. The network 214 can be implemented using a wireless network or any kind of physical network implementation known in the art. Additionally, each end user device 210 can be communicatively coupled to the computing device 202 through multiple networks (e.g., intranet and Internet) so that not all end user devices 210 are coupled to the computing device 202 through the same network. One or more of the end user devices 210 and the computing device 202 can be connected to the network 214 in a wireless fashion. In one embodiment, the network 214 includes an intranet and the one or more end user devices 210 execute a user interface application (e.g., a web browser) to contact the computing device 202 through the network 214. In another embodiment, the one or more end user devices 210 are connected directly (i.e., not through the network 214) to the computing device 202. In another embodiment, the computing device 202 and the end user device 210 are incorporated into a single device configured to execute the PCB cost estimation instructions and having user interface components. Thus, in some such embodiments, the network 214 is not included in the system 200.

In some embodiments, historical data is stored in the memory 208 of the computing device 202. However, in the embodiment shown in FIG. 2, a separate storage device 224 stores the historical data 226. In this embodiment, the storage device 224 is communicatively coupled to the computing device 202 via the network 214. However, in other embodiments, the separate storage device 224 can be coupled directly to the computing device 202 (i.e. not through the network 214). In such embodiments, the storage device 224 can include one or more disk drives or direct access storage devices coupled to the computing device 202. One specific type of direct access storage device is a readable and writable compact disc (CD-RW) drive, which may store data to and read data from a CD-RW. Other types of direct access storage devices include, but are not limited to, rotating magnetic disk drive storage devices, and arrays of disk drives configured to appear as a single large storage device.

In some embodiments, the storage device 224 includes one or more databases containing historical modeling and manufacturing data and corresponding configuration parameters, values, methods, and properties, as well as other related information as discussed above. The storage device 224 can also store informative data in some embodiments. It will be understood by those of ordinary skill in the art that the storage device 224 may also comprise other structures, such as an XML file on the file system or distributed over a network (e.g., one of networks 214), or from a data stream from another server located on a network. In addition, all or a portion of the storage device 224 may alternatively be located on an end user device 210.

Thus, the processor 204 includes or functions with software programs, firmware or other computer readable instructions for carrying out various methods, process tasks, calculations, and control functions, used in the estimating the PCB cost for a PCB design.

These instructions are typically stored on any appropriate computer readable or processor-readable medium used for storage of computer readable instructions or data structures. The computer readable medium can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk—Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc.

Hence, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

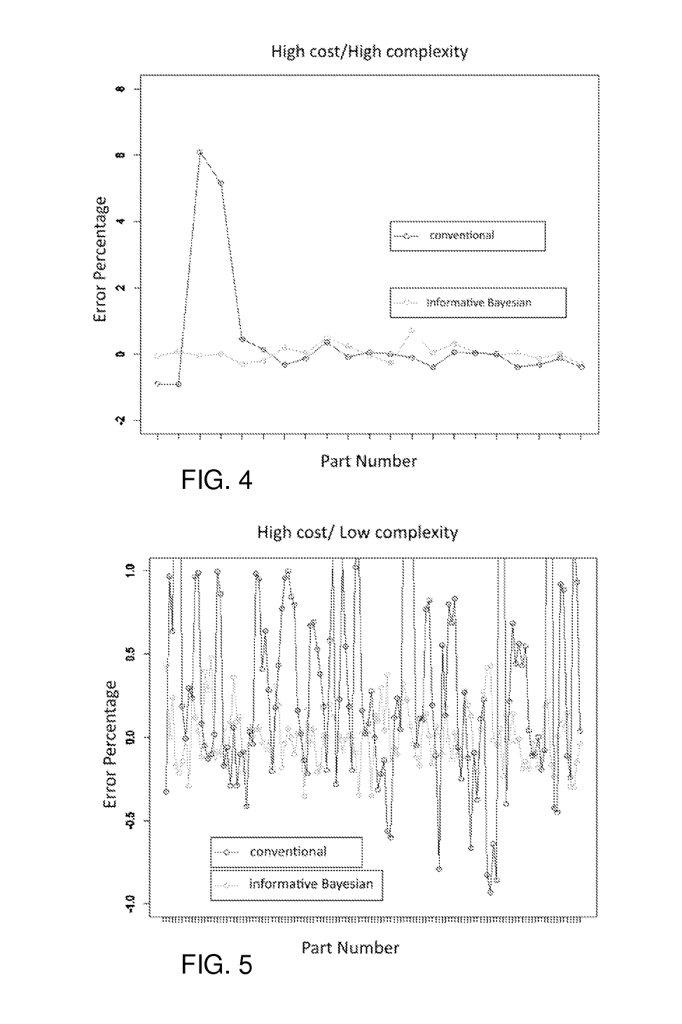

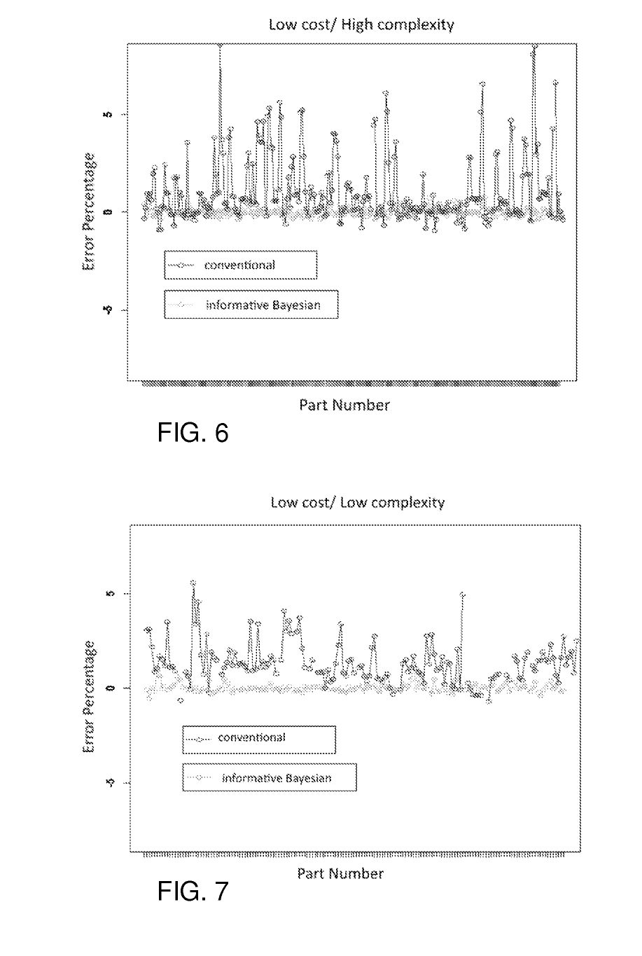

FIGS. 4-7 depict a comparison of results from embodiments of the informative Bayesian method described herein and a conventional technique for estimating PCB cost. In particular, each of FIGS. 4-7 depicts the error percentage for each of a plurality of PCB designs (part number) corresponding to one of the four categories: High cost/High complexity, High cost/Low complexity, Low cost/High complexity, and Low cost/Low complexity. As can be seen in each of FIGS. 4-7, the overall error in the cost estimates from the informative Bayesian method described herein is smaller than the overall error for the cost estimates using a conventional technique. Thus, the embodiments of the informative Bayesian method described herein enable more accurate predictions of the cost of a PCB design.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

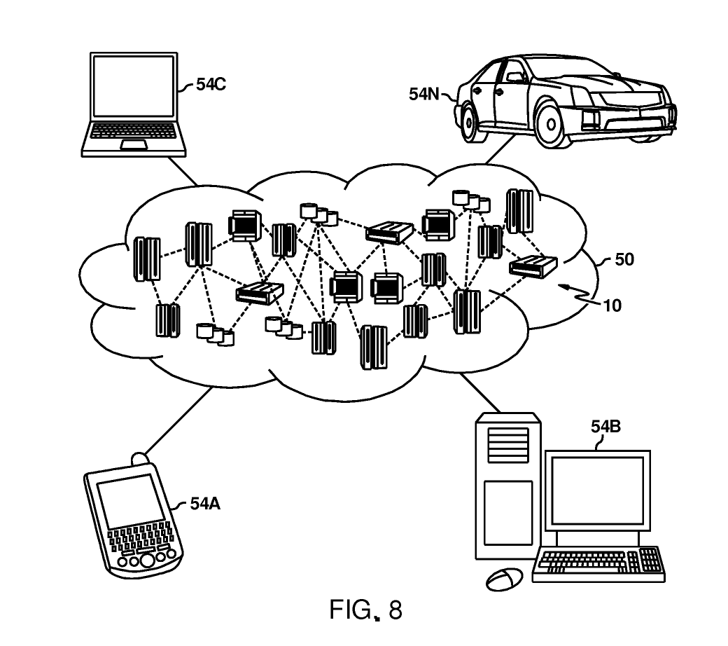

FIG. 8 depicts an illustrative cloud computing environment 50. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

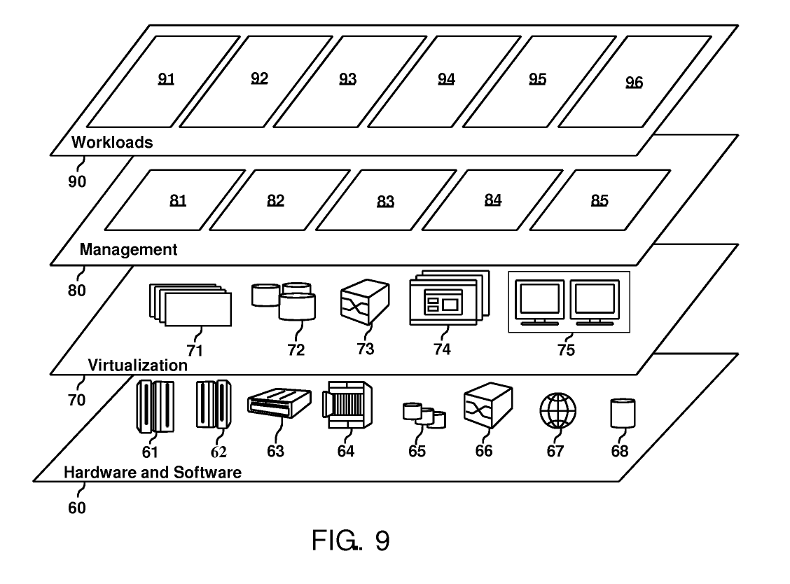

FIG. 9 depicts a set of functional abstraction layers provided by the cloud computing environment 50 shown in FIG. 8. It should be understood in advance that the components, layers, and functions shown in FIG. 8 are intended to be illustrative only. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and PCB cost estimation processing 96. The PCB cost estimation processing 96 implements the functions described above with respect to FIGS. 1 and 2.

### EXAMPLE EMBODIMENTS

Example 1 includes a method of estimating cost of a printed circuit board. The method comprises receiving a set of parameters for a printed circuit board (PCB) design; statistically classifying the PCB design into one of a plurality of categories; generating a regression model corresponding to the respective category of the PCB design based on statistical analysis of historical data; and determining a probability distribution for one or more coefficients in the regression model based on informative data. The informative data includes data regarding expected relationships between one or more predictors in the regression model and cost of the printed circuit board. The method further comprises determining a respective value for each of the one or more coefficients based on the probability distribution; and generating a cost estimate for the PCB design based on the regression model using the respective determined values for each of the one or more coefficients.

Example 2 includes the method of Example 1 and further comprises determining a difference between the cost estimate for the PCB design and an actual cost of the PCB design; and updating the historical data and the regression model based on the difference between the cost estimate for the PCB design and the actual cost of the PCB design.

Example 3 includes the method of any of Examples 1-2, wherein the plurality of categories includes four categories.

Example 4 includes the method of any of Examples 1-3, wherein statistically classifying the PCB design into one of the plurality of categories comprises statistically classifying the PCB design based on the number of layers in the PCB design and the surface area of the PCB design.

Example 5 includes the method of any of Examples 1-4, wherein determining a respective value for each of the one or more coefficients based on the probability distribution comprises determining a likelihood of a logarithmic transformation of the regression model based on current values of the one or more coefficients; and computing a respective updated value for each of the one or more coefficients which increase the likelihood of the logarithmic transformation.

Example 6 includes the method of any of Examples 1-5, wherein determining a respective value for each of the one or more coefficients based on the probability distribution includes determining a respective magnitude and sign for each of the one or more coefficients that are consistent with physical understanding of the printed circuit board design.

Example 7 includes the method of any of Examples 1-6, wherein the historical data includes cost variations from different suppliers.

Example 8 includes a system comprising a storage device configured to store historical data for previous printed circuit board designs; an interface configured to receive a new printed circuit board design having a plurality of parameters; and a processor configured to statistically classify the new printed circuit board design into one of a plurality of categories based on the historical data and one or more of the plurality of parameters. The processor is further configured to generate a regression model corresponding to the respective category of the new printed circuit board design based on statistical analysis of the historical data and to determine a probability distribution for one or more coefficients in the regression model based on informative data. The informative data includes data regarding expected relationships between one or more predictors in the regression model and cost of the printed circuit board. The processor is further configured to determine a respective value for each of the one or more coefficients based on the probability distribution and to generate a cost estimate for the new printed circuit board design based on the regression model using the respective determined values for each of the one or more coefficients.

Example 9 includes the system of Example 8, wherein the processor is further configured to determine a difference between the cost estimate for the new printed circuit board design and an actual cost of the new printed circuit board design; and to update the historical data and the regression model based on the difference between the cost estimate for the new printed circuit board design and the actual cost of the new printed circuit board design.

Example 10 includes the system of any of Examples 8-9, wherein the plurality of categories includes four categories.

Example 11 includes the system of any of Examples 8-10, wherein the processor is further configured to statistically classify the new printed circuit board design into one of the plurality of categories based on the number of layers in the new printed circuit board design and the surface area of the new printed circuit board design.

Example 12 includes the system of any of Examples 8-11, wherein the processor is configured to determine a respective value for each of the one or more coefficients based on the probability distribution by determining a likelihood of a logarithmic transformation of the regression model based on current values of the one or more coefficients; and by computing a respective updated value for each of the one or more coefficients which increase the likelihood of the logarithmic transformation.

Example 13 includes the system of any of Examples 8-12, wherein the processor is configured to determine a respective magnitude and sign for each of the one or more coefficients that are consistent with physical understanding of the printed circuit board design.

Example 14 includes the system of any of Examples 8-13, wherein the historical data includes cost variations from different suppliers.

Example 15 includes a program product comprising a processor-readable storage medium having program instructions embodied thereon, wherein the program instructions are configured, when executed by at least one programmable processor, to cause the at least one programmable processor to receive a set of parameters for a printed circuit board (PCB) design; statistically classify the PCB design into one of a plurality of categories; generate a regression model corresponding to the respective category of the PCB design based on statistical analysis of historical data; and determine a probability distribution for one or more coefficients in the regression model based on informative data. The informative data includes data regarding expected relationships between one or more predictors in the regression model and cost of the printed circuit board. The program instructions are further configured to cause the at least one programmable processor to determine a respective value for each of the one or more coefficients based on the probability distribution; and generate a cost estimate for the PCB design based on the regression model using the respective determined values for each of the one or more coefficients.

Example 16 includes the program product of Example 15, wherein the program instructions are further configured to cause the at least one programmable processor to determine a difference between the cost estimate for the PCB design and an actual cost of the PCB design; and update the historical data and the regression model based on the difference between the cost estimate for the PCB design and the actual cost of the PCB design.

Example 17 includes the program product of any of Examples 15-16, wherein the program instructions are further configured to cause the at least one programmable processor to statistically classify the PCB design into one of the plurality of categories based on the number of layers in the PCB design and the surface area of the PCB design.

Example 18 includes the program product of any of Examples 15-17, wherein the program instructions are further configured to cause the at least one programmable processor to determine a respective value for each of the one or more coefficients based on the probability distribution by determining a likelihood of a logarithmic transformation of the regression model based on current values of the one or more coefficients; and computing a respective updated value for each of the one or more coefficients which increase the likelihood of the logarithmic transformation.

Example 19 includes the program product of any of Examples 15-18, wherein the program instructions are further configured to cause the at least one programmable processor to determine a respective magnitude and sign for each of the one or more coefficients that are consistent with physical understanding of the printed circuit board design.

Example 20 includes the program product of any of Examples 15-19, wherein the historical data includes cost variations from different suppliers.

Although specific embodiments have been illustrated and described herein, it will be appreciated by those of ordinary skill in the art that any arrangement, which is calculated to achieve the same purpose, may be substituted for the specific embodiments shown.

What is claimed is:

1. A method of estimating cost of a printed circuit board, the method comprising:
receiving a set of parameters for a printed circuit board (PCB) design;
statistically classifying the PCB design into one of a plurality of categories;
generating a regression model corresponding to the respective category of the PCB design based on statistical analysis of historical data;
determining a probability distribution for one or more coefficients in the regression model based on informative data, wherein informative data includes data regarding expected relationships between one or more predictors in the regression model and cost of the printed circuit board;
determining a respective value for each of the one or more coefficients based on the probability distribution; and
generating a cost estimate for the PCB design based on the regression model using the respective determined values for each of the one or more coefficients.

2. The method of claim 1, further comprising:
determining a difference between the cost estimate for the PCB design and an actual cost of the PCB design; and
updating the historical data and the regression model based on the difference between the cost estimate for the PCB design and the actual cost of the PCB design.

3. The method of claim 1, wherein the plurality of categories includes four categories.

4. The method of claim 1, wherein statistically classifying the PCB design into one of the plurality of categories comprises statistically classifying the PCB design based on the number of layers in the PCB design and the surface area of the PCB design.

5. The method of claim 1, wherein determining a respective value for each of the one or more coefficients based on the probability distribution comprises:
determining a likelihood of a logarithmic transformation of the regression model based on current values of the one or more coefficients; and
computing a respective updated value for each of the one or more coefficients which increase the likelihood of the logarithmic transformation.

6. The method of claim 1, wherein determining a respective value for each of the one or more coefficients based on the probability distribution includes determining a respective magnitude and sign for each of the one or more coefficients that are consistent with physical understanding of the printed circuit board design.

7. The method of claim 1, wherein the historical data includes cost variations from different suppliers.

8. A system comprising:
a storage device configured to store historical data for previous printed circuit board designs;
an interface configured to receive a new printed circuit board design having a plurality of parameters; and
a processor configured to statistically classify the new printed circuit board design into one of a plurality of categories based on the historical data and one or more of the plurality of parameters;
wherein the processor is further configured to generate a regression model corresponding to the respective category of the new printed circuit board design based on statistical analysis of the historical data and to determine a probability distribution for one or more coefficients in the regression model based on informative data, the informative data including data regarding expected relationships between one or more predictors in the regression model and cost of the printed circuit board;
wherein the processor is further configured to determine a respective value for each of the one or more coefficients based on the probability distribution and to generate a cost estimate for the new printed circuit board design based on the regression model using the respective determined values for each of the one or more coefficients.

9. The system of claim 8, wherein the processor is further configured to determine a difference between the cost estimate for the new printed circuit board design and an actual cost of the new printed circuit board design; and to update the historical data and the regression model based on the difference between the cost estimate for the new printed circuit board design and the actual cost of the new printed circuit board design.

10. The system of claim 8, wherein the plurality of categories includes four categories.

11. The system of claim 8, wherein the processor is further configured to statistically classify the new printed circuit board design into one of the plurality of categories based on the number of layers in the new printed circuit board design and the surface area of the new printed circuit board design.

12. The system of claim 8, wherein the processor is configured to determine a respective value for each of the one or more coefficients based on the probability distribution by determining a likelihood of a logarithmic transformation of the regression model based on current values of the one or more coefficients; and by computing a respective updated value for each of the one or more coefficients which increase the likelihood of the logarithmic transformation.

13. The system of claim 8, wherein the processor is configured to determine a respective magnitude and sign for each of the one or more coefficients that are consistent with physical understanding of the printed circuit board design.

14. The system of claim 8, wherein the historical data includes cost variations from different suppliers.

15. A program product comprising a processor-readable storage medium having program instructions embodied thereon, wherein the program instructions are configured, when executed by at least one programmable processor, to cause the at least one programmable processor to:
receive a set of parameters for a printed circuit board (PCB) design;
statistically classify the PCB design into one of a plurality of categories;
generate a regression model corresponding to the respective category of the PCB design based on statistical analysis of historical data;
determine a probability distribution for one or more coefficients in the regression model based on informative data, wherein informative data includes data regarding expected relationships between one or more predictors in the regression model and cost of the printed circuit board;
determine a respective value for each of the one or more coefficients based on the probability distribution; and
generate a cost estimate for the PCB design based on the regression model using the respective determined values for each of the one or more coefficients.

16. The program product of claim 15, wherein the program instructions are further configured to cause the at least one programmable processor to:
determine a difference between the cost estimate for the PCB design and an actual cost of the PCB design; and
update the historical data and the regression model based on the difference between the cost estimate for the PCB design and the actual cost of the PCB design.

17. The program product of claim 15, wherein the program instructions are further configured to cause the at least one programmable processor to statistically classify the PCB design into one of the plurality of categories based on the number of layers in the PCB design and the surface area of the PCB design.

18. The program product of claim 15, wherein the program instructions are further configured to cause the at least one programmable processor to determine a respective value for each of the one or more coefficients based on the probability distribution by:
determining a likelihood of a logarithmic transformation of the regression model based on current values of the one or more coefficients; and
computing a respective updated value for each of the one or more coefficients which increase the likelihood of the logarithmic transformation.

19. The program product of claim 15, wherein the program instructions are further configured to cause the at least one programmable processor to determine a respective magnitude and sign for each of the one or more coefficients that are consistent with physical understanding of the printed circuit board design.

20. The program product of claim 15, wherein the historical data includes cost variations from different suppliers.
